(19) United States
(12) Patent Application Publication
(10) Pub. No.: US 2018/0295011 A1
(43) Pub. Date: Oct. 11, 2018

(54) ARCHITECTURES AND METHODS FOR MANAGEMENT OF IN-VEHICLE NETWORKED CONTROLLERS AND DEVICES

(71) Applicant: GM GLOBAL TECHNOLOGY OPERATIONS LLC, Detroit, MI (US)

(72) Inventors: Shige Wang, Northville, MI (US); Chang Liu, Ann Arbor, MI (US)

(73) Assignee: GM GLOBAL TECHNOLOGY OPERATIONS LLC, Detroit, MI (US)

(21) Appl. No.: 15/479,664

(22) Filed: Apr. 5, 2017

(51) Int. Cl. H04L 12/24; H04L 29/08; G06F 1/32; G06F 13/364

(52) U.S. Cl. CPC H04L 41/044; G06F 13/364; G06F 1/3287; H04L 67/12

(57) ABSTRACT

Disclosed are control algorithms and system architectures for managing operation of networked controllers and devices, including vehicles with an onboard network of electronic control units (ECU) and control logic for governing the snoozing and waking of these ECUs. A method for managing a motor vehicle's in-vehicle network of ECUs includes: determining status vectors for a group of the ECUs, each status vector indicating whether the corresponding ECU is awake or asleep; determining device roles for these ECUs—slave or master; determining an assigned hierarchy for selecting the ECUs as the master device; receiving a mode change signal indicating an ECU intends to transition to the asleep state or to the awake state; and, responsively, modifying the respective device role for one ECU from master to slave and the respective device role for another ECU from slave to master based on the assigned hierarchy and the status vectors for the ECUs.

The present disclosure relates generally to networks of electronic controllers and computing devices. More specifically, aspects of this disclosure relate to system architectures and control logic for sleep/wakeup management of in-vehicle networked controllers and devices that provide distributed control of vehicle functions.

Current production motor vehicles, such as the modern-day automobile, are originally equipped with a network of electronic controllers and computing devices that are distributed throughout the vehicle to help perform different vehicle functions. These vehicle functions, whether operator-controlled or automated, may include controlling vehicle door locks, seat position, cruise control, entertainment system components, heating ventilation and air conditioning (HVAC), arming/disarming of theft-prevention alarms, interior and exterior lighting, powertrain operation and system diagnostics, and electric window position, as well as other functions. While some onboard electronic control units (ECU), such as engine control modules (ECM) and brake system control modules (BCM), are dedicated to controlling a single subsystem, most other ECUs function in interoperable groups to control vehicle operation. Many vehicle control tasks are performed by several ECUs working in unison and coordinating their operation via a data link. A conventional ECU, for example, may contain a portion of the control logic for several unrelated vehicle control tasks, yet may not contain the complete control logic for any single control task.

In-vehicle ECUs typically communicate with one another via a network communication bus, which may be implemented singly or as a serial communication interface in the form of a local area network (LAN). The communication topology may be supported by gateway/bridging devices, such as Ethernet switches. In addition to the requisite hardware for transferring signals between networked ECUs, a reliable communication protocol is implemented to help ensure that primary and ancillary tasks can be performed synchronously. One such task is network management to provide a system-wide common methodology for handling such events as: orderly start up (activation) of communication capabilities; orderly shutdown (deactivation) of communication capabilities; and predictable recovery from detectable communication errors. Orderly start up and shutdown helps to ensure that ECUs can synchronize their signal reception expectations with signal transmission availability of other ECUs. If synchronization does not occur, an ECU may interpret the lack of signal transmission as a false-positive failure of one of the other ECUs and may adopt safe default signal values.

To help reduce electrical power consumption in existing vehicle electrical infrastructures, ECUs that are not actively controlling vehicle functionality can be temporarily placed in a low power “standby” or “sleep” state. For example, power window and seat control ECUs, which are used infrequently relative to other controllers, can usually be maintained in standby. Existing vehicle network management strategies often require that all ECUs in a designated group be simultaneously activated (“awake”) and deactivated (“asleep”). In a “master-slave” vehicle network scheme, for example, in-vehicle devices are clustered into virtual groups, with a single ECU assigned as “master” for each group of eligible devices. The master ECU may exhibit unidirectional control over the remaining “slave” ECUs in the group, including the ability to wake and snooze each slave ECU. In such systems, the master ECU synchronizes start up and shut down of all assets assigned to their respective group. Robust network designs are typically able to start ECU sets on demand without disrupting the control operations being performed by the ECUs that are already awake.

### SUMMARY

Disclosed herein are control algorithms and system architectures for managing sleep and wakeup of in-vehicle networked controllers and devices, methods for implementing and methods for constructing such algorithms/architectures, and motor vehicles equipped with an onboard network of electronic control units (ECU) and control logic for governing the snoozing and waking of these networked ECUs. By way of example, and not limitation, there is presented an architecture with services and protocols to dynamically manage the individual, networked controllers and devices entering into sleep mode and waking to normal operation mode. The architecture adopts a master-slave relation for the devices, with a primary master device periodically sending network management frame prompts via multicast distribution. In this instance, the master is also responsible for approving which device(s) may go to sleep and may also be operable to prompt sleeping slave devices to wake up. Sleep mode and variations thereof, such as sleeping, snoozing, asleep, etc., can be typified as a reduced “low” power mode relative to normal operation mode; sleep mode is not an off state requiring the device reboot before becoming fully operational. A device consumes some energy while sleeping, e.g., in order to power local memory and to be able to respond to a wake-up event.

All devices, including the master and any slave devices, may request to sleep or wake based upon individual operation statuses. In general, a slave device queries the master to approve a sleep-to-wake or wake-to-sleep mode change request. When a master device goes to sleep or a slept device wakes up, a new master may be selected using a master selection protocol. The architecture references a master selection table that is stored as calibration values on one or more or all devices and defines an order of priority (hierarchy) of devices to be designated as master. A status table is concomitantly used to track the sleep/wake status of each device and its current role (master or slave).

In addition to normal communication and management frames, two types of network frames may be employed to carry information for updating the respective states of each device, to maintain a consistent view of devices on the network, and to help manage device sleep and wakeup. A network management frame (NMF) is sent by a master device and contains Master Information with a source identifier and a data field indicating which devices are sleeping and which are awake using a bit vector, e.g., with bit=0 for asleep and bit=1 for awake. A NMF is transmitted to all awake devices, and all slave devices update their status table accordingly. A request frame (REQ) is used by a slave device or a waking device to send a request. A REQ is used, for example, when the network starts to select a master and when a slave device decides to sleep. For purposes of this disclosure, the terms “controller” and “ECU” and “device” may be used interchangeably unless explicitly disclaimed.

The protocol for master selection is invoked, for example, when a device in a group wakes up—the waking device waits for NMF to indicate if the network is running and a master exists. When the device receives the NMF, it runs a wakeup management protocol to join the network. If the NMF does not arrive before timeout, the device assumes the network is not running and promotes itself to master. The master selection protocol is then invoked to select a device with the highest priority to be master. When a slave device has no activity and wishes to sleep, it invokes a sleep management protocol and sends a REQ to the master device for approval. If the master device confirms in the next NMF with a corresponding status vector bit set to sleep, the device may go to sleep; otherwise, the device remains awake until receiving NMF with its status vector bit set to sleep. If the master decides to sleep, the master sends a NMF with its bit set to sleep and wakes one or more devices and/or awake slaves go through the master selection process. If a device is awaken and receives the NMF, it invokes the wakeup management protocol to determine whether it has higher priority than the current master. If so, it assumes the role as master and sends out an NMF with this information; the old master then becomes a slave when it receives the newly transmitted NMF.

Attendant benefits for at least some of the disclosed concepts include a flexible, rather than fixed, master-slave architecture design of networked controllers that enables each networked device to awaken (or sleep) as necessary without having to wake (or snooze) all other devices. Disclosed systems, methods and devices allow the designation and associated functionality of a master device to be transferred to other devices within a designated group, making the network configuration more flexible and energy efficient. Other attendant benefits may include mitigating or otherwise preventing a network from going down when a master device fails, thus improving the availability and reliability of the system. All devices in a group may be designed to use the same calibration tables to determine master device priorities, and to run the same algorithms, so the overall system design is simplified and the communication protocols are optimized for speed. Disclosed concepts may be incorporated into applications outside of vehicle systems, such as mass data storage, cloud computing, internet of things (IoT), and other computer network architectures.

Aspects of the present disclosure are directed to control logic and computer-executable algorithms for managing operation of networked controllers and devices. Disclosed, for example, is a method for managing an onboard network of ECUs of a motor vehicle. A group of the vehicle's onboard ECUs are connected via a communication interface, such as an Ethernet switch, and are each operable to transition between awake and asleep states. This method includes, in any order and in any combination with any of the disclosed features and options: determining respective status vectors for the ECUs in the group, each status vector indicating whether the corresponding ECU is awake or asleep; determining respective device roles for the ECUs in the group, each device role designating the corresponding ECU as a slave device or a master device; determining an assigned hierarchy for the group of ECUs, the assigned hierarchy including priority labels (e.g., 1^{st}, 2^{nd}, 3^{rd}, etc.) for selecting each ECU as the master device; transmitting or receiving a mode change signal, e.g., embedded in an REQ or NMF packet, indicating an ECU in the group intends to transition from the awake state to the asleep state or from the asleep state to the awake state; and, responsive to this mode change signal, modifying the respective device role for a first ECUs in the group from master device to slave device and modifying the respective device role for a second ECU in the group from slave device to master device, both modifications being based on the assigned hierarchy and the status vectors for the ECUs.

Other aspects of the present disclosure are directed to motor vehicles equipped with an onboard network of controllers and devices, and control logic for governing the operation of these controllers/devices. A “motor vehicle,” as used herein, may include any relevant vehicle platform, such as passenger vehicles (internal combustion engine, hybrid electric, full electric, fuel cell, fuel cell hybrid, fully or partially autonomous, etc.), commercial vehicles, industrial vehicles, tracked vehicles, off-road and all-terrain vehicles (ATV), farm equipment, boats, airplanes, etc. In an example, a motor vehicle is presented that includes a vehicle body, a communication interface, and multiple ECUs attached to the vehicle body, where a group of the ECUs are communicatively connected via the communication interface. Each ECU in the group is programmed to: determine, via a locally stored Status Table, respective status vectors for the ECUs in the group, each status vector indicating whether the corresponding ECU is awake or asleep; determine, via the locally stored Status Table, respective device roles for the ECUs, each device role designating the corresponding ECU as a slave or a master; determine, via a locally stored Master Selection Table, an assigned hierarchy for the ECUs in the group, the assigned hierarchy including respective priority labels for selecting the ECUs as the master device; and, receive or transmit a mode change signal indicating that ECU or one of the other ECUs in the group intends to transition from the awake state to the asleep state or the asleep state to the awake state. Responsive to receipt/transmission of a mode change signal, the respective device role for a first ECU in the group is changed from master to slave, while the respective device role for a second ECU is concomitantly changed from slave to master based on the assigned hierarchy and the status vectors.

Additional aspects of the present disclosure are directed to non-transitory, computer readable media storing instructions for execution by at least one of one or more processors of an in-vehicle network of ECUs. These instructions, when executed, cause the network of ECUs to perform various steps, including: retrieving from a lookup table or otherwise determining status vectors for the ECUs in a virtual group, each status vector indicating whether an ECU is awake or asleep; retrieving from a lookup table or otherwise determining respective device roles for the ECUs in the group, each device role designating an ECU as a slave device or a master device; retrieving from a lookup table or otherwise determining an assigned hierarchy for the group of ECUs, the assigned hierarchy prioritizing the ECUs for selection as the master device; receiving/transmitting a mode change signal indicating an ECUs in the group intends to transition to the asleep state or to the awake state; and, responsive to the mode change signal, modifying the respective device role for a first ECU in the group to slave device while contemporaneously modifying the respective device role for a second ECU to master device based on the assigned hierarchy and the status vectors for the ECUs in the group.

The above summary is not intended to represent every embodiment or every aspect of the present disclosure. Rather, the foregoing summary merely provides an exemplification of some of the novel aspects and features set forth herein. The above features and advantages, and other features and advantages of the present disclosure, will be readily apparent from the following detailed description of representative embodiments and representative modes for carrying out the present disclosure when taken in connection with the accompanying drawings and the appended claims. Moreover, this disclosure expressly includes any and all combinations and subcombinations of the elements and features presented above and below.

### BRIEF DESCRIPTION OF THE DRAWINGS

FIG. 1 is a schematic illustration of a representative motor vehicle with a network of in-vehicle controllers and devices in accordance with aspects of the present disclosure.

FIG. 2 is a schematic diagram of a representative master-slave system architecture for managing sleep and wakeup of in-vehicle networked controllers and devices in accord with aspects of the disclosed concepts.

FIG. 3 is a flowchart for a master selection protocol that may correspond to instructions executed by onboard control-logic circuitry, programmable electronic control unit, or other computer-based device of a motor vehicle in accord with aspects of the disclosed concepts.

FIG. 4 is a flowchart for a sleep management protocol that may correspond to instructions executed by onboard control-logic circuitry, programmable electronic control unit, or other computer-based device of a motor vehicle in accord with aspects of the disclosed concepts.

FIG. 5 is a flowchart for a wakeup management protocol that may correspond to instructions executed by onboard control-logic circuitry, programmable electronic control unit, or other computer-based device of a motor vehicle in accord with aspects of the disclosed concepts.

The present disclosure is susceptible to various modifications and alternative forms, and some representative embodiments have been shown by way of example in the drawings and will be described in detail herein. It should be understood, however, that the novel aspects of this disclosure are not limited to the particular forms illustrated in the appended drawings. Rather, the disclosure is to cover all modifications, equivalents, combinations, subcombinations, permutations, groupings, and alternatives falling within the scope and spirit of the disclosure as defined by the appended claims.

### DETAILED DESCRIPTION

This disclosure is susceptible of embodiment in many different forms. There are shown in the drawings and will herein be described in detail representative embodiments of the disclosure with the understanding that these representative embodiments are to be considered an exemplification of the principles of the disclosure and are not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed: the singular includes the plural and vice versa; the words “and” and “or” shall be both conjunctive and disjunctive; the word “all” means “any and all”; the word “any” means “any and all”; and the words “including” and “comprising” and “having” mean “including without limitation.” Moreover, words of approximation, such as “about,” “almost,” “substantially,” “approximately,” and the like, may be used herein in the sense of “at, near, or nearly at,” or “within 3-5% of,” or “within acceptable manufacturing tolerances,” or any logical combination thereof, for example.

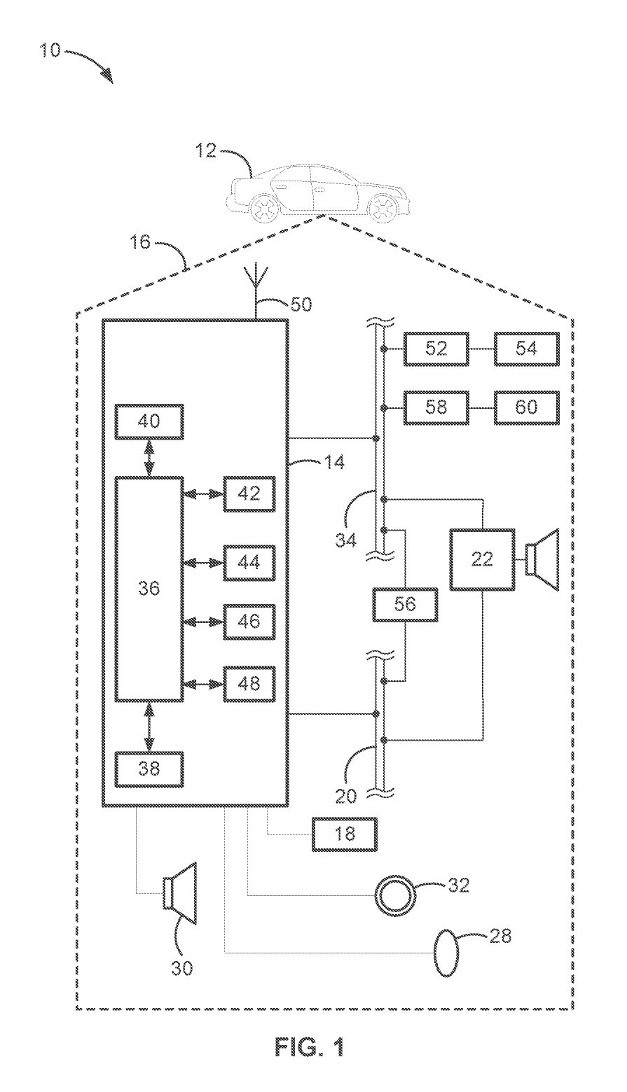

Referring now to the drawings, wherein like reference numbers refer to like features throughout the several views, there is shown in FIG. 1 a schematic illustration of a representative automobile, which is designated generally at 10 and portrayed herein for purposes of discussion as a four-door sedan-style passenger vehicle. Packaged within a vehicle body 12 of the automobile 10, e.g., distributed throughout the different vehicle compartments, is an onboard network of computing devices, such as the assorted devices and control units described below. The illustrated automobile 10—also referred to herein as “motor vehicle” or “vehicle” for short—is merely an exemplary application with which many aspects and features of this disclosure may be practiced. In the same vein, implementation of the present concepts for the specific number and type of computing devices illustrated in FIG. 1 should also be appreciated as an exemplary application of the concepts and features disclosed herein. As such, it will be understood that aspects and features of this disclosure may be applied to any number and type and arrangement of networked controller and devices, utilized for non-automotive applications, and implemented by any logically relevant type of motor vehicle. Moreover, only select components of the vehicle 10 have been shown and will be described in additional detail herein. Nevertheless, the motor vehicles and network architectures discussed herein can include numerous additional and alternative features, and other well-known peripheral components, for example, for carrying out the various methods and functions of this disclosure. Lastly, the drawings presented herein are not necessarily to scale and are provided purely for instructional purposes. Thus, the specific and relative dimensions shown in the drawings are not to be construed as limiting.

The representative vehicle 10 of FIG. 1 is originally equipped with a vehicle telecommunication and information (colloquially referred to as “telematics”) unit 14 that communicates with a wireless communication system (e.g., cell towers, base stations and/or mobile switching centers (MSCs), etc.; not shown). Some of the other vehicle hardware 16 shown generally in FIG. 1 includes, as non-limiting examples, a display device 18, a microphone 28, a speaker 30, and input controls 32 (e.g., buttons, knobs, switches, keyboards, touchscreens, etc.). Generally, these hardware 16 components enable a user to communicate with the telematics unit 14 and other systems and system components within the vehicle 10. Microphone 28 provides a vehicle occupant with means to input verbal or other auditory commands, and can be equipped with an embedded voice processing unit utilizing human/machine interface (HMI) technology. Conversely, speaker 30 provides audible output to a vehicle occupant and can be either a stand-alone speaker dedicated for use with the telematics unit 14 or can be part of a vehicle audio system 22. The audio system 22 is operatively connected to a network connection interface 34 and an audio bus 20 to receive analog information, rendering it as sound, via one or more speaker components.

Communicatively coupled to the telematics unit 14 is a network connection interface 34, suitable examples of which include twisted pair/fiber optic Ethernet switch, internal/external parallel/serial communication bus, a LAN, a controller area network (CAN), a media oriented system transfer (MOST), a local interconnection network (LIN), and the like. Other appropriate communication interfaces may include those that conform with known ISO, SAE, and IEEE standards and specifications. The network connection interface 34 enables the vehicle hardware 16, including the telematics unit 14, to send and receive signals with each other and with various systems and subsystems both outside the vehicle body 12 and within the vehicle 10 to perform various vehicle functions, such as unlocking a vehicle door, positioning and orienting a vehicle seat, controlling engine throttle, engaging/disengaging the brake system, and the like. For instance, telematics unit 14 receives and/or transmits data to/from a safety system ECU 52, an engine control module (ECM) 54, an infotainment application module 56, sensor interface module(s) 58, and assorted other vehicle ECUs 60, such as a transmission control module (TCM), a climate control module (CCM), a brake system module (BCM), etc.

With continuing reference to FIG. 1, telematics unit 14 is an onboard computing device that provides a mixture of services, both individually and through its communication with other networked devices. This telematics unit 14 is generally composed of one or more processors, which may be embodied as a discrete microprocessor, an application specific integrated circuit (ASIC), a central processing unit (CPU) 36, etc., operatively coupled to one or more electronic memory devices 38, each of which may take on the form of a CD-ROM, magnetic disk, IC device, semiconductor memory (e.g., various types of RAM or ROM), etc., and a real-time clock (RTC) 46. Communication capabilities with remote, off-board networked devices is provided via one or more or all of a cellular chipset/component 40, a wireless modem 42, a navigation and location chipset/component 44 (e.g., global positioning system (GPS)), a short-range wireless communication device 48 (e.g., a Bluetooth® unit), and/or a dual antenna 50. It should be understood that the telematics unit 14 may be implemented without one or more of the above listed components, or may include additional components and functionality as desired for a particular end use.

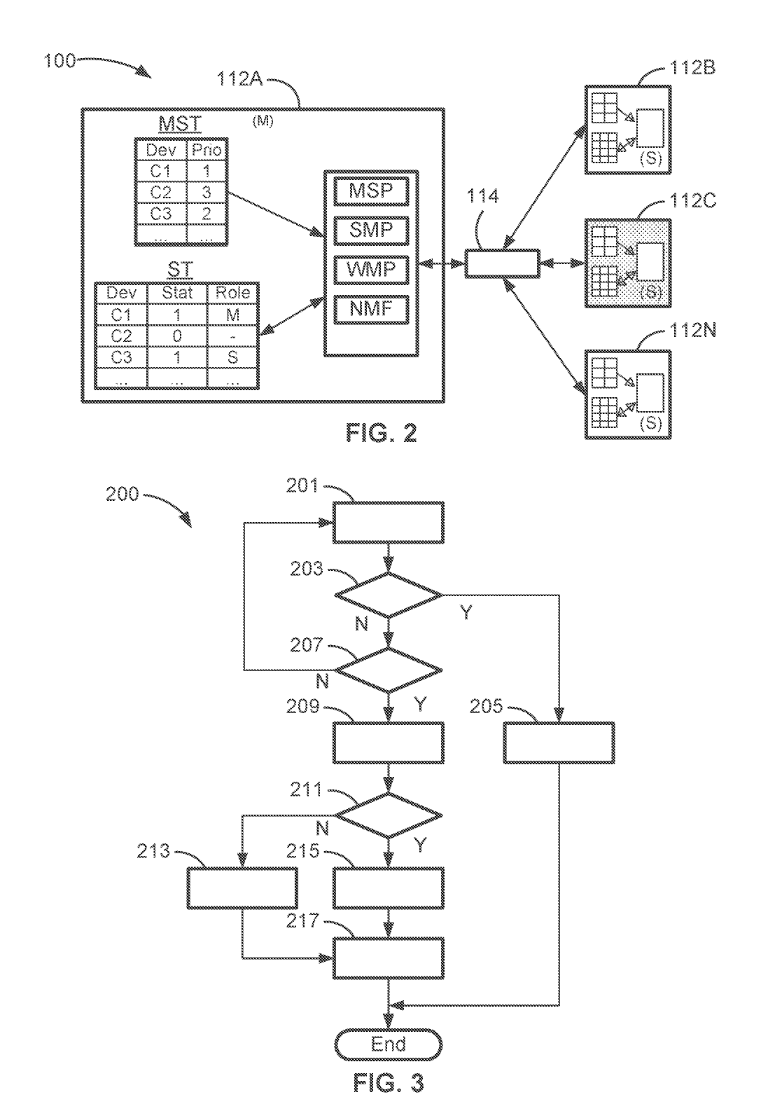

Turning next to FIG. 2, there is shown a representative master-slave system architecture, designated generally as 100, for managing operation of assorted networked ECUs, electronic hardware and other computing devices. The example architecture shown in FIG. 2, for instance, includes an assortment of ECUs 112A, 112B, 112C . . . 112N that are communicatively connected to one another by a communication interface 114. As shown, the first ECU 112A is currently assigned the role of master device (M), with the remaining ECUs 112B, 112C . . . 112N acting in the role of slave devices (S). While differing in appearance, it is envisioned that any of the features disclosed above with reference to the in-vehicle network architecture of FIG. 1 can be incorporated, singly, collectively, or in any combination, into the networked ECU architecture of FIG. 2, and vice versa. By way of non-limiting example, the ECUs 112A-112N of FIG. 2 may take on any of the corresponding in-vehicle device configurations described above with respect to FIG. 1, such as telematics unit 14, display device 18, audio system 22, safety system ECU 52, ECM 54, infotainment application module 56, sensor interface module(s) 58, other vehicle ECUs 60, etc. In the same vein, the communication interface 114 of FIG. 2 may take on any of the forms described above with respect to the network connection interface 34 of FIG. 1.

System architecture 100 is designed to allow the individual controllers 112A-112N to dynamically and cooperatively switch between a low-power sleep mode (shown with cross-hatching in ECU 112B of FIG. 2) and a normal-power awake mode (e.g., shown without cross-hatching in ECUs 112A, 112B and 112N of FIG. 2) based on their respective operational requirements without having to sleep/wake every device in a designated group. A master device, for example, may sleep or wake itself, and may snooze or awaken other devices, based on its own operational needs or the needs of other node(s) in the group. A slave device, on the other hand, may request to sleep or wake, or may temporarily adopt the role of master device, based on its own operational needs or the needs of other node(s) in the group. By implementing the protocols described herein, this system can reliably manage device snoozing and waking, which in turn will help to reduce energy consumption without losing overall functionality. By way of example, and not limitation, a single ECU is dynamically designated as the sole master device to maintain group operation through network management frame packets transmitted, e.g., through multicast distribution with bounded clock drifts. With this feature, a master device is not required to stay awake perpetually, nor is it required that all slave devices sleep when a mater device sleeps. Furthermore, all devices in a designated group may be programmed to run the same or similar master control algorithms, so the overall architecture design is simplified and more robust.

Managing operation of the networked ECUs of FIG. 2 may necessitate accumulating, storing, retrieving and/or updating system information that is maintained in a readily accessible data structure. This system information may include: (1) status vectors for all ECUs in a designated group, where each respective status vector indicates whether the corresponding ECU is in the awake state or in the asleep state; (2) device roles for all ECUs in a designated group, where each respective device role designates the corresponding ECU as a slave device or a master device; and (3) an order of priority (also referred to herein as “assigned hierarchy”) that prioritizes all ECUs in a designated group when selecting which ECU will be temporarily assigned as master device. According to the representative architecture of FIG. 2, master device (M) ECU 112A maintains system information in a Master Selection Table (MST) and a Status Table (ST). The MST maintains the assigned hierarchy that defines the prioritized order of devices when selecting a master device, where the assigned priority labels (e.g., 1^{st}, 2^{nd}, 3^{rd}, etc.) for the devices may be determined in advance and stored as calibration values. Conversely, the ST tracks and maintains the status vectors (bit=0 for asleep; bit=1 for awake) and device roles (M=master; S=slave), and may be updated periodically and/or in real-time according to information in NMF for consistent view. It is desirable, for at least some configurations, that every ECU 112A-112N in the designated group store in a respective local memory device individual copies of the ST and MST. In so doing, each device can retrieve, call, or otherwise determine the status vectors, the device roles and/or the assigned hierarchy by referencing the ST or MST.

All devices in the representative architecture 100 of FIG. 2, whether master or slave, may sleep or wake based upon group or individual operational needs. In general, when a device wishes to sleep or wake, it transmits a mode change signal indicating the intent to transition from the awake to the asleep state or from the asleep to the awake state. Two types of network frames may be employed, for example, to carry information between devices for managing device sleep and wakeup, for updating the state and role of each device, and to maintain a consistent view of devices on the network. By way of non-limiting example, when a master device intends to transition to the asleep state and/or wishes to snooze or awaken a slave device, a mode change signal indicating such change is included in a network management frame (NMF) packet sent by the master to some or all of the slave devices, e.g., via multicast distribution (one-to-many in computer network group communication). If the master device wishes to wake (or snooze) a slave device, the NMF packet sent by the master may include a command for the slave device to transition to the awake state (or the asleep state). This command may be in the form of a corresponding change to the respective status vector of the slave device maintained in the ST, and may be sent prior to the role of master migrating to a new device and the previously designated master device contemporaneously going to sleep. In this regard, if the master device wishes to sleep, the NMF packet sent by the master may include: a mode change signal (status vector change) indicative of the same; and a master selection prompt for selecting a new master. Responsively, one or more or all slave devices may individually respond with a request frame (REQ) packet that includes a master designation request to be selected as the master device prior to master device going to sleep.

Continuing with examples of network frame options, if a sleeping device wishes to wake, a mode change signal indicating this intent is included in a REQ packet sent by the sleeping ECU to a master ECU (if one is awake) and/or other accessible ECUs in the group. This REQ packet my further include a master designation request, and may be sent prior to modifying the respective device roles for any devices to/from slave or master. Responsively, the REQ-transmitting ECU may receive from an awake master device a NMF packet approving the request—e.g., the respective status vector and device role of the REQ-transmitting ECU updated in the ST to indicate awake and master device, respectively. Conversely, if the REQ-transmitting ECU does not receive a NMF packet from a master device, e.g., prior to expiration of a specified period of time (timeout condition), the REQ-transmitting ECU may be required to continue in sleep mode. Alternatively, the REQ-transmitting ECU may temporarily select itself as master device, e.g., until the master selection process can be initiated to select a higher-priority ECU as master device. Now, if an awake slave device wishes to sleep, a REQ packet including a corresponding mode change request is sent by the slave device to the presently designated master device. The master ECU will respond to this REQ packet with an NMF packet that either approves or denies the mode change request, as will be described in further detail below.

To support a collaborative sleep/wake process, the role of master device can migrate amongst the assets assigned to a respective group, where the respective device role for a master ECU in the group is modified from master to slave while the respective device role for a slave ECU in the group is modified from slave to master. The master selection process, which is described in additional detail below, is based on the assigned hierarchy of the ECUs in the group and the present operating modes for these ECUs. After modifying the respective device role for a slave device to master, the newly designated master ECU will multicast or otherwise transmit to the remaining ECUs a network management frame packet with an updated Status Table, which includes any modified device roles and any modified status vectors. After the NMF packet is sent, each of the receiving ECUs in the group will update their individual ST that is stored by their respective local memory to include the modified device roles and modified status vectors. For at least some embodiments, the NMF and REQ packets are short in size to minimize overhead for transmission and to reduce processing burden. As another option, both packets include a source identifier indicative of which device sent the packet, and a status bit vector change with intended device ID (for a NMF) or a mode change request with/without a master designation request (for a REQ).

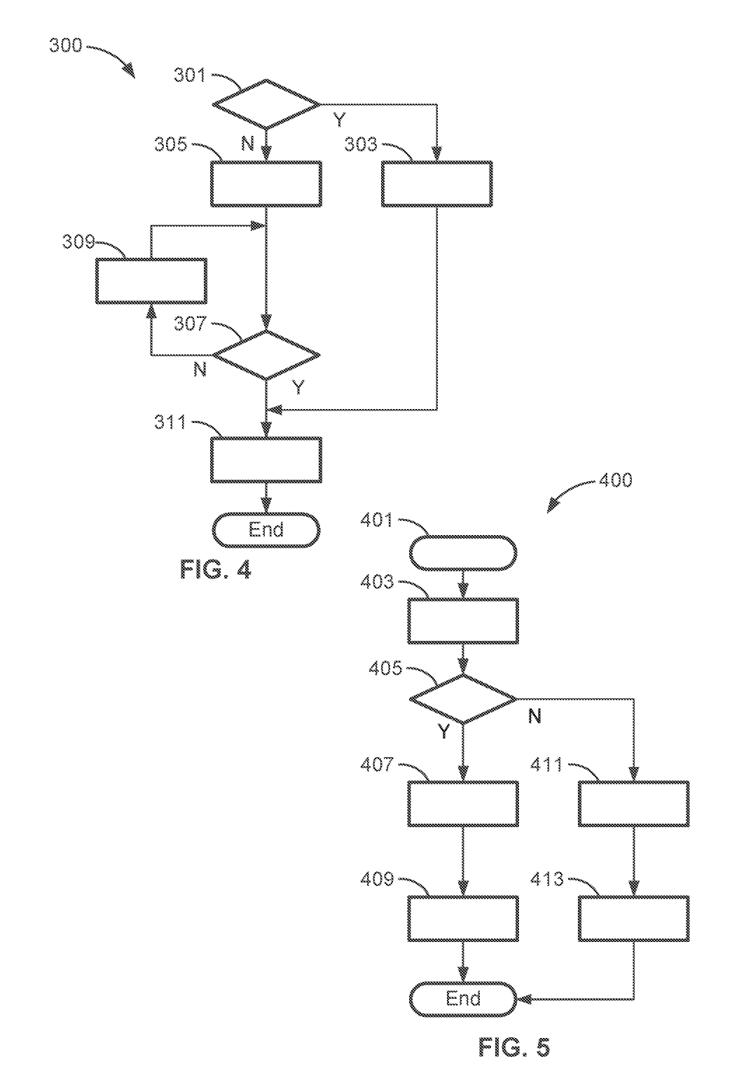

FIG. 3 illustrates a series of representative operations for executing a master selection protocol, for example, via a networked ECU that is presently designated as the master device. In this regard, FIG. 4 illustrates a series of representative operations for executing a sleep management protocol, for example, via any networked ECU in a designated group, whether presently designated master or slave, that intends to transition to sleep mode. Conversely, FIG. 5 illustrates a series of representative operations for executing a wakeup management protocol, for example, via any networked ECU in a designated group, whether presently designated master or slave, that intends to wake. Some or all of the operations portrayed in FIGS. 3-5 and described herein can be representative of algorithms or methods 200, 300 and 400, respectively, that corresponds to processor-executable instructions that can be stored, for example, in main or auxiliary memory, and executed, for example, by an ECU, a CPU, a dedicated IC device, an on-board or remote control logic circuit, or a network of devices, to perform any or all of the above and/or below described functions associated with the disclosed concepts.

Turning first to FIG. 3, the master selection protocol 200 is generally employed when: a master device intends to sleep and a new master should then be selected to maintain system operation; a master device does not currently exist (e.g. when system is first initialized); or a new device joins a group or a device wakes up and it is determined this new/waking device has higher priority than the existing master. In at least some embodiments, each device makes a local decision with status information available from all other devices. The method 200 starts at block 201 with waiting to receive a NMF packet, e.g., from a presently designated master device. If it is determined at block 203 that a NMF packet is received (Block 203=Y), the method 200 proceeds to block 205 to initiate a wakeup process, such as wakeup management protocol 400 of FIG. 5. However, if it is determined at block 203 that a NMF packet is not received (Block 203=N), the method 200 proceeds to block 207 to assess whether a timeout condition has occurred, namely if a specified time period to wait for NMF has expired. Responsive to a determination that the timeout condition has not occurred (Block 207=N), the method 200 loops back to block 201 to wait for a NMF packet.

With continuing reference to FIG. 3, if an NMF packet is not received, as determined at block 203, and a timeout condition has in fact occurred, as determined at block 207, the device executing the master selection protocol 200 will multicast a REQ packet to other networked devices with a master designation request to be selected as the master device, at indicated at block 209. At block 211, the method 200 determines if a NMF packet is received with a corresponding ST device role change that approves/denies the soliciting device's request to be master. If it is determined at block 211 that a NMF packet approving the request is not received (Block 211=N), the requesting device temporarily designates itself as master device and sends out a NMF packet to the other networked devices indicative of this change, as indicated at block 213. However, if it is determined at block 211 that a NMF packet is received but denying the role change request to master (Block 211=Y), the method 200 proceeds to block 215 with designating the requesting device as a slave device. Method 200 proceeds from both blocks 213 and 215 to block 217 with updating the ST to reflect any device role changes.

With reference next to FIG. 4, the sleep management protocol 300 is generally employed by a network device that intends to transition to sleep mode, e.g., when there is no correlated activity for that device and/or another device in the network does not need to interact with that device. By way of example, and not limitation, a slave device may request to sleep, but generally requires a master device to approve the request. While the decision to sleep and the transition to sleep is made locally, it requires “global” approval by a master. If approved, the master device updates NMF with the corresponding slave bit set to S; once the requesting slave device receives a NMF packet with its bit set to S, it may goes to sleep. As a further example, when master device wishes to transition to sleep mode, the designation of “master” is transferred to a slave device. Slave devices may detect this change by occurrence of a timeout condition of NMF; these slave devices will enter the master selection phase, such as master selection protocol 200 of FIG. 3. Locally saved ST are updated when receiving NMF according to status vector changes.

The method 300 of FIG. 4 begins at block 301 with the device that is executing the sleep management protocol determining if it is presently designated master. If it is determined at block 301 that the device is, in fact, the acting master (Block 301=Y), the method 300 proceeds to block 303 with the master device multicasting a NMF packet with its status vector set to sleep (bit=0). On the other hand, if it is determined that the device is not the acting master device (Block 301=N), the device will unicast a REQ packet to the existing master with a mode change request indicating it intends to transition to the asleep state, as indicated at block 305. At block 307, the method 300 determines if a NMF packet is received with an approval of the slave device's mode change request (e.g., respective status vector bit=0 in ST). If it is determined at block 307 that the NMF approval is not received (Block 307=N), the method 300 loops to block 309 and keeps the requesting device awake until the requisite NMF packet is received. However, if the NMF approval is received (Block 307=Y), the method proceeds to block 311, sleeps the requesting device and, optionally, updates ST.

Any of the networked devices in a designated group may initiate the wakeup management protocol 400 of FIG. 5 and begin to wake, for example, when activated by input/output (I/O) signal from another vehicle device and/or activated by another device in the network. After wake up, a device goes through similar process as master selection and: checks if a master exists by “listening” for a NMF packet; if a master exists, but with a lower priority, transfer master designation; otherwise, send a REQ packet with a master designation request and update ST according to NMF. All other devices on the network may then need to update their ST according to NMF to maintain a consistent view across all devices. The method 400 of FIG. 5 begins at block 401 with a device waking up and concomitantly proceeds to block 403 with receiving a NMF packet, e.g., from a presently designated master device. At block 405, the method 400 determines, e.g., from the MST in the NMF packet, if the NMF-transmitting master device has a lower or lowest priority. If it is determined at block 405 that the master device does have a lower/lowest priority (Block 405=Y), the method 400 proceeds to block 407 to update the ST with the respective device role of the receiving device changed to master device and then, at block 409, multicasting an NMF packet via the newly designated master device with the updated ST. On the other hand, if that master device does not have a lower/lowest priority (Block 405=N), the method 400 proceeds to block 411 with the NMF-receiving device transmitting a REQ packet with a mode change signal indicating the intent to transition from asleep state to the awake state and, at block 413, updating the ST with any corresponding mode change.

Aspects of this disclosure may be implemented, in some embodiments, through a computer-executable program of instructions, such as program modules, generally referred to as software applications or application programs executed by an onboard vehicle computer. The software may include, in non-limiting examples, routines, programs, objects, components, and data structures that perform particular tasks or implement particular abstract data types. The software may form an interface to allow a computer to react according to a source of input. The software may also cooperate with other code segments to initiate a variety of tasks in response to data received in conjunction with the source of the received data. The software may be stored on any of a variety of memory media, such as CD-ROM, magnetic disk, bubble memory, and semiconductor memory (e.g., various types of RAM or ROM).

Moreover, aspects of the present disclosure may be practiced with a variety of computer-system and computer-network configurations, including multiprocessor systems, microprocessor-based or programmable-consumer electronics, minicomputers, mainframe computers, and the like. In addition, aspects of the present disclosure may be practiced in distributed-computing environments where tasks are performed by remote-processing devices that are linked through a communications network. In a distributed-computing environment, program modules may be located in both local and remote computer-storage media including memory storage devices. Aspects of the present disclosure may therefore, be implemented in connection with various hardware, software or a combination thereof, in a computer system or other processing system.

Any of the methods described herein may include machine readable instructions for execution by: (a) a processor, (b) a controller, and/or (c) any other suitable processing device. Any algorithm, software, or method disclosed herein may be embodied in software stored on a tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an application specific integrated circuit (ASIC), a programmable logic device (PLD), a field programmable logic device (FPLD), discrete logic, etc.). Further, although specific algorithms are described with reference to flowcharts depicted herein, persons of ordinary skill in the art will readily appreciate that many other methods of implementing the example machine readable instructions may alternatively be used.

While aspects of the present disclosure have been described in detail with reference to the illustrated embodiments, those skilled in the art will recognize that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined in the appended claims. Moreover, the present concepts expressly include any and all combinations and subcombinations of the preceding elements and features.

What is claimed:

1. A method for managing an onboard network of electronic control units (ECU) of a motor vehicle, a group of the ECUs being connected via a communication interface and each being operable to transition between an awake state and an asleep state, the method comprising:
determining respective status vectors for the ECUs in the group, each of the status vectors indicating whether the corresponding ECU is in the awake state or in the asleep state;
determining respective device roles for the ECUs in the group, each of the device roles designating the corresponding ECU as a slave device or a master device;
determining an assigned hierarchy for the ECUs in the group, the assigned hierarchy including respective priority labels for selecting the ECUs as the master device;
transmitting a mode change signal indicating one of the ECUs intends to transition from the awake state to the asleep state or from the asleep state to the awake state; and
responsive to transmitting the mode change signal, modifying the respective device role for a first of the ECUs in the group from master device to slave device and modifying the respective device role for a second of the ECUs in the group from slave device to master device based on the assigned hierarchy and the status vectors for the ECUs in the group.

2. The method of claim 1, wherein the mode change signal indicates the intent to transition from the awake state to the asleep state, is included in a network management frame (NMF) packet transmitted by the first ECU and received by the second ECU, and is sent prior to modifying the respective device role for the first ECU from master device to slave device.

3. The method of claim 2, wherein the NMF packet is sent by the first ECU to other ECUs in the group via multicast distribution, the method further comprising receiving, by the first ECU from one or more of the other ECUs prior to modifying the respective device role for the second ECU to master device, a master designation request to be selected as the master device.

4. The method of claim 2, wherein the NMF packet sent by the first ECU to the second ECU includes a command for the second ECU to transition from the asleep state to the awake state prior to modifying the respective device role for the second ECU to master device.

5. The method of claim 1, further comprising transmitting, from the second ECU to other ECUs in the group after modifying the respective device role for the second ECU to master device, a network management frame (NMF) packet, the NMF packet including a Status Table (ST) with the modified device roles of the first and second ECUs and a modified status vector for the first ECU indicating the first ECU is asleep.

6. The method of claim 5, further comprising updating, via each of the other ECUs in the group, an individual Status Table (ST) stored by a respective local memory device of the ECU to include the modified device roles of the first and second ECUs and the modified status vector for the first ECU indicating the first ECU is asleep.

7. The method of claim 1, wherein the mode change signal indicates the intent to transition from the sleep state to the awake state, is included in a request frame (REQ) packet transmitted by the second ECU and received by the first ECU, and is sent prior to modifying the respective device role for the second ECU from slave device to master device.

8. The method of claim 7, further comprising receiving, by the second ECU from the first ECU in response to the REQ packet, a network management frame (NMF) packet with the status vector and device role of the first ECU indicating awake and master device, respectively.

9. The method of claim 7, further comprising, in response to the second ECU not receiving a network management frame (NMF) packet from one of the other ECUs in the group prior to expiration of a preset timeout period, the second ECU selecting itself as master device.

10. The method of claim 1, further comprising receiving, by the second ECU from a third of the ECUs in the group after modifying the respective device role for the second ECU from slave device to master device, a request frame (REQ) packet including a mode change request to transition from the awake state to the asleep state.

11. The method of claim 10, further comprising transmitting, from the second ECU to the third ECU, a network management frame (NMF) packet with an approval or a denial of the mode change request.

12. The method of claim 1, wherein the status vectors and the device roles are stored in a Status Table, and wherein the assigned hierarchy is stored in a Master Selection Table, each of the ECUs in the group of ECUs storing in a respective local memory device individual copies of the Status Table and the Master Selection Table.

13. The method of claim 1, wherein determining the status vectors and determining the device roles includes referencing a Status Table stored in a local memory device, and wherein determining the assigned hierarchy includes referencing a Master Selection Table stored in the local memory device.

14. A motor vehicle comprising:
a vehicle body;
a communication interface;
a plurality of electronic control units (ECU) attached to the vehicle body, a group of the ECUs being connected via the communication interface and operable to transition between an awake state and an asleep state, each of the ECUs in the group being programmed to:
determine, via a locally stored Status Table, respective status vectors for the ECUs in the group, each of the status vectors indicating whether the corresponding ECU is in the awake state or in the asleep state;
determine, via the locally stored Status Table, respective device roles for the ECUs in the group, each of the device roles designating the corresponding ECU as a slave device or a master device;
determine, via a locally stored Master Selection Table, an assigned hierarchy for the ECUs in the group, the assigned hierarchy including respective priority labels for selecting the ECUs as the master device; and
receive or transmit a mode change signal indicating the ECU or one of the other ECUs in the group intends to transition from the awake state to the asleep state or the asleep state to the awake state,
wherein, responsive to receiving or transmitting the mode change signal, the respective device role for a first of the ECUs in the group is changed from master device to slave device and the respective device role for a second of the ECUs in the group is changed from slave device to master device based on the assigned hierarchy and the status vectors.

15. A non-transitory, computer readable medium having stored thereon instructions for execution by at least one of one or more processors of an onboard network of electronic control units (ECU) of a motor vehicle, a group of the ECUs being connected via a communication interface and each being operable to transition between an awake state and an asleep state, the instructions causing the network of ECUs to perform steps comprising:
determining respective status vectors for the ECUs in the group, each of the status vectors indicating whether the corresponding ECU is in the awake state or in the asleep state;
determining respective device roles for the ECUs in the group, each of the device roles designating the corresponding ECU as a slave device or a master device;
determining an assigned hierarchy for the ECUs in the group, the assigned hierarchy including respective priority labels for selecting the ECUs as the master device;
transmitting a mode change signal indicating one of the ECUs intends to transition from the awake state to the asleep state or the asleep state to the awake state; and
responsive to transmitting the mode change signal, modifying the respective device role for a first of the ECUs in the group from master device to slave device and modifying the respective device role for a second of the ECUs in the group from slave device to master device based on the assigned hierarchy and the status vectors for the ECUs in the group.

16. The non-transitory, computer readable medium of claim 15, wherein the mode change signal indicates the intent to transition from the awake state to the asleep state, is included in a network management frame (NMF) packet transmitted by the first ECU and received by the second ECU, and is sent prior to modifying the respective device role for the first ECU from master device to slave device.

17. The non-transitory, computer readable medium of claim 16, wherein the NMF packet is sent by the first ECU to other ECUs in the group via multicast distribution, the method further comprising receiving, by the first ECU from one or more of the other ECUs prior to modifying the respective device role for the second ECU to master device, a master designation request to be selected as the master device.

18. The non-transitory, computer readable medium of claim 16, wherein the NMF packet sent by the first ECU to the second ECU includes a command for the second ECU to transition from the asleep state to the awake state prior to modifying the respective device role for the second ECU to master device.

19. The non-transitory, computer readable medium of claim 15, wherein the mode change signal indicates the intent to transition from the sleep state to the awake state, is included in a request frame (REQ) packet transmitted by the second ECU and received by the first ECU, and is sent prior to modifying the respective device role for the second ECU from slave device to master device.

20. The non-transitory, computer readable medium of claim 19, further comprising instructions causing the network of ECUs to:
receive, by the second ECU from the first ECU in response to the REQ packet, a network management frame (NMF) packet with the status vector and the device role of the first ECU indicating awake and master device, respectively; or
in response to the second ECU not receiving the NMF packet from one of the other ECUs in the group prior to expiration of a preset timeout period, the second ECU selecting itself as master device.
